(19) United States
(12) Patent Application Publication
(10) Pub. No.: US 2008/0089733 A1
(43) Pub. Date: Apr. 17, 2008

(54) Combination Toothbrush and Toothpaste Apparatus with Dosed Dispensing

(76) Inventor: Aaron J. Lochak, Elizabeth, NJ (US)

Correspondence Address: Law Office of Michael J. Feigin, 306 Howard Ave, Flr 3, Passaic, NJ, 07055, US

(21) Appl. No.: 11/870,527

(22) Filed: Oct. 11, 2007

Related U.S. Application Data
(60) Provisional application No. 60/850,801, filed on Oct. 12, 2006.

(51) Int. Cl. B43K 5/06; A46B 11/04; B43K 29/00

(52) U.S. Cl. 401/180; 401/195; 401/270; 401/272

(57) ABSTRACT

The invention provides an apparatus for dispensing a dosed volume of toothpaste onto bristles of a toothbrush. A toothpaste holder and toothbrush are formed in combination in a single unitary structure. The toothbrush heads a replaceable and an internal channel provides fluid communication between a toothbrush head and a volume of toothpaste in a handle region. The volume of toothpaste may be placed in a cartridge. In order to facilitate dosed dispensing, notched regions may be provided to provide friction or an audible sound to inform a user when a dose has been properly dispensed.

THIS APPLICATION CLAIMS PRIORITY TO U.S. PROVISIONAL APPLICATION No. 60/850,801, FILED OCT. 12, 2006, THE CONTENTS OF WHICH ARE INCORPORATED HEREIN BY REFERENCE IN THEIR ENTIRETY.

### BACKGROUND OF THE INVENTION

Toothbrushing is one of the most important parts of personal hygiene. In addition to freshening the breath and strengthening the teeth, proper brushing also kills germs and bacteria that grow inside the mouth. According to the United States Office of the Surgeon General, the most common chronic childhood disease in the country presently is tooth decay. A staggering 512 million school hours a year are lost due to dental illness.

Adults also suffer from various forms of dental disease, leading to costly trips to the dentist and possibly complications requiring painful oral surgeries. The American Dental Association recommends that teeth be brushed at least twice daily, preferably after meals. However, this recommendation is often difficult to follow. Consumers have busy days and often are on travels away from home and cannot take time out to fumble with messy toothpaste tubes and toothbrushes.

With conventional toothpaste tubes, it is difficult to measure the amount of toothpaste to be used. Squeezes of the tube do not produce uniform amounts of toothpaste. However, brushing teeth has a hygienic and medicinal purpose, so that a more exact measurement is desired. When too much toothpaste is used, some goes to waste. When too little is used, the teeth are not cleaned as effectively as possible.

Prior art inventions show toothbrushes having a handle containing a reservoir for toothpaste that may be selectively dispensed. Such toothbrushes tend to fall into two categories: (a) those in which the toothpaste is normally not under pressure but is selectively pressurized to dispense the paste; and (b) those in which the paste is under constant pressure and is dispensed by activation of a valve.

However, the prior art combination toothbrushes and toothpaste dispensers are often difficult to use, expensive to manufacture, and create hygiene problems of their own. For example, many such toothbrushes require filling the dispenser with toothpaste before use, which is messy and time consuming. Further, such toothbrushes do not solve the prior art problem of controlling the amount of toothpaste used. A child or adult will typically dispense a variable amount of toothpaste onto a toothpaste tube when utilizing such a combination of a toothbrush and a toothpaste dispenser. The user's control of the volume of toothpaste dispensed is poor.

Thus, the prior art inventions typically result in toothpaste falling messily off the toothbrush, as well as the use of too much or too little toothpaste. A device which can dispense toothpaste onto a toothbrush in a measured amount and a neat and clean manner is therefore desirable.

It is an object of the invention to dispense a controlled or dosed amount of toothpaste onto the bristles of a toothbrush.

It is a further object of the invention to provide a sanitary and clean device that can be used for accurate delivery of a volume of medicinal products, with limited or no waste or loss of toothpaste.

It is a further object of the invention to provide a unitary structure comprising toothpaste and toothbrush for easy handling and maintenance.

It is a yet further object of the invention to provide a device that is a pleasure to use.

### SUMMARY OF THE INVENTION

The invention comprises a combination toothbrush and toothpaste dispenser with calibrated dosed dispensing, comprising a proximal head formed integrally with a distal stem, the head further comprising a proximal bristled-region. The bristled-region further comprises perpendicularly extending bristles. A channel extends through the stem and head and opens into the bristled region at one or more pores in the head. The channel further opens at a distal end of the stem. A cylindrical housing or handle comprising a toothpaste-containing cavity is also provided. A proximal region of the toothpaste-containing cavity is connectable with a distal region of the stem and is in fluid communication with the channel of the stem. A spring-loaded internal plunger is disposed at a distal end of the toothpaste-containing cavity and seals the toothpaste above the plunger. The spring-loaded internal plunger is coupled to a spring-loaded button.

Upon each use of the button, the plunger extends a fixed distance into the toothpaste-containing cavity, and a dosed volume of toothpaste exits from the cylindrical housing.

In embodiments of the invention, a toothpaste cartridge adapted for placement within the handle may be used, and a stem on the adapter with a protruding distal end may be used to connect or puncture the cartridge and allow fluid communication into the channel from the cartridge. The device used to cause a dose of toothpaste to enter the channel may be a depressible button, a lever, or a twistable button; a clicking noise is produced. The head region of the invention is replaceable.

In embodiments of the invention, calibrated notches are provided to aid in accurately dosing the toothpaste onto the brush and possibly to produce a clicking noise upon each use of the button.

### BRIEF DESCRIPTION OF THE DRAWINGS

FIG. 1 shows a perspective view of the combination toothbrush and toothpaste dispenser of an embodiment of the invention.

FIG. 2 shows a side plan view of the combination toothbrush and toothpaste dispenser of an embodiment of the invention.

FIG. 3 shows a blown apart version of FIG. 2.

FIG. 4a shows a top perspective view of a cartridge with a puncture center region as used with an embodiment of the invention.

FIG. 4b shows a bottom perspective view of an adapter of an embodiment of the invention.

FIG. 5a shows a side cutaway view of a handle as used in an embodiment of the invention and having notched recesses and plunger.

FIG. 5b shows a side cutaway view of a handle as used in an embodiment of the invention and having a smooth interior and plunger.

FIG. 6a shows a bottom perspective view of an embodiment of the invention.

FIG. 6b shows a bottom perspective view of another embodiment of the invention having a button positioned at the bottom end.

### DETAILED DESCRIPTION

With reference now to the drawings, the embodiments of the new and improved combination toothbrush and toothpaste dispenser with dosed dispensing and clean and hygienic operation embodying the principles and concepts of the present invention will be described.

It will be noted in the various figures that the device relates to a combination toothbrush and toothpaste dispenser with dosed dispensing to accurately provide a medically approved or otherwise preset and desired amount of toothpaste to a toothbrush. In its broadest context, the device comprises of a toothbrush portion, a plunger, a mechanism for advancing the plunger, and, in embodiments of the invention, a toothpaste cartridge. Such components are individually configured and combined with respect to each other so as to attain the desired objective.

The device of the invention can be made from any material which can maintain its shape when exposed to typical indoor and outdoor temperatures, as well as hot and cold water. Preferably, the combination toothbrush and toothpaste dispenser is made from a polymeric material which can be molded to form the desired shape, such as polyethylene, polypropylene, high density linear polyethylene, polyvinyl chloride (PVC), polyethylene terephthalate (PET), amorphous polyethylene terephthalate (APET), high density polyethylene/ethylvinyl acetate (HDPE/EVA) copolymer, glycol-modified polyethylene terephthalate (PETG), or combinations thereof. Optionally, the polymeric material selected may include dyes, colorants, UV inhibitors, other chemical additives that would further stabilize the polymer for use, or a combination thereof. The device is preferably injection-molded from the polymeric material, but can be extruded or stamped if these processing methods would be more appropriate for the material selected.

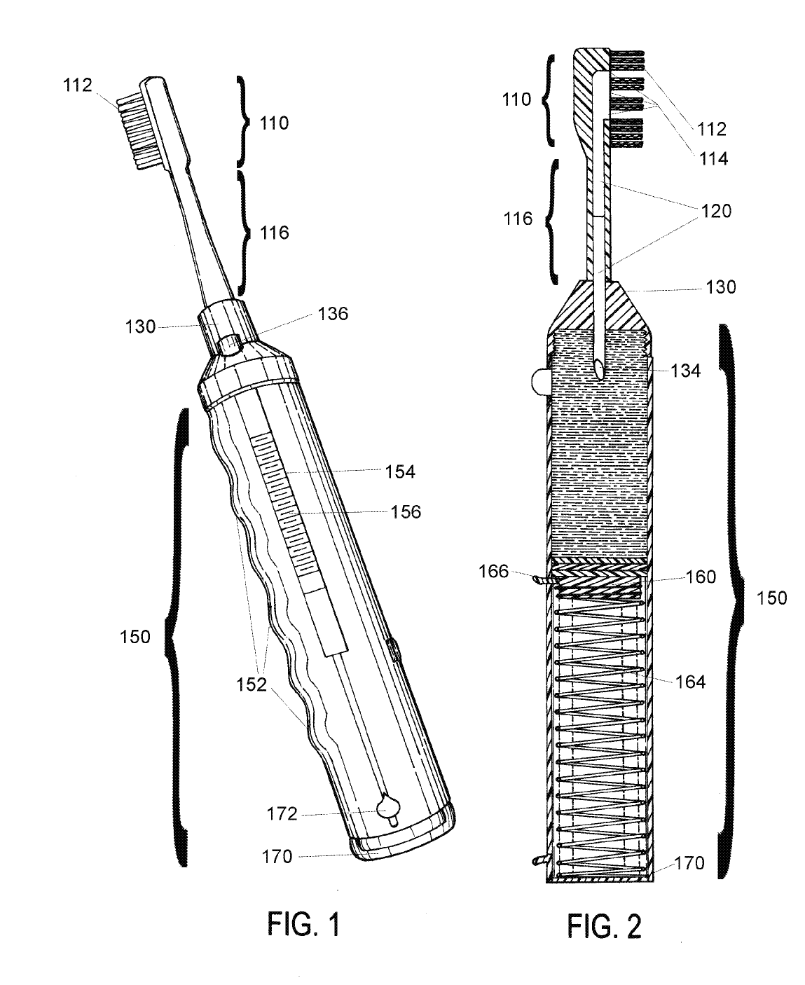

Referring to the figures in general and FIGS. 1 and 2 in particular, embodiments of the invention will now be described in general terms. FIG. 1 shows a perspective view of the combination toothbrush and toothpaste dispenser of an embodiment of the invention, while FIG. 2 shows a side plan view of the combination toothbrush and toothpaste dispenser of an embodiment of the invention. An internal channel 120 extends from pores 114 of a head region 110 through a stem 116 and through an adapter 130 into a handle region 150. The channel 120 may extend from the adapter 130 into the handle region by way of a stem 134. Thus, fluid communication from the handle region 150 to the pores 114 is provided. When the device of the invention is in an assembled condition, a sealed inner region is created between the pores 114 and handle region 150, connected by the channel 120. As will be described in greater detail below, in operation, a cavity in the handle 150 comprising toothpaste is compressed in a controlled manner via various means of control that will be described in greater detail below. This controlled compression forces a dose of toothpaste into the channel 120. In the assembled condition of the invention, the channel 120 is sealed from the handle 150 to the pores 114, so that the dose of toothpaste is eventually forced to exit through the pores 114.

Now follows a description of embodiments of the invention in greater detail. A head region 110 comprises a toothbrush portion comprising a plurality of bristles 112 forming a bristled-region and pores 114. The pores 114 provide portals or openings between, or in close proximity to, the bristles 112 and open into an internal channel 120. The pores 114 allow toothpaste to exit from the channel 120 to fill the bristles 112 with toothpaste. Thus, the head region 110 is comprised of proximal bristles 112 extending out perpendicularly from substantially a top portion of the head region 110, and an internal channel 120 extends from the pores 114 through a stem 116.

In an embodiment of the invention, the pores are sized in such a manner as to seal which is caused by the drying of toothpaste when the device is not in use. This is achieved by the small diameter of each individual pore and does not substantially affect the nature or quality of the toothpaste because of the miniscule volume affected. However, the placement of the pores 114 combined with the small diameter of each pore allows a temporary seal to form in the pores between usages.

The head region 110 is replaceable. Thus, when the bristles 112 of the bristled region become old or worn out, the head region 110, which is inexpensive to manufacture and procure, can be disposed of and a new head region 110 can be used.

The head region 110 snaps into an adapter 130. The adapter is best depicted in FIG. 4b, wherein a bottom perspective view of the adapter is shown. The adapter 130 is a connecting piece between the stem 116 and the handle region 150. As described above, the pores 114 are in fluid communication with the internal channel 120. The internal channel 120 is hollow and allows for toothpaste to pass through an interior region. The channel 120 extends from the pores 114 through the stem 116 and through the adapter 130 by way of the internal channel 120, which further extends through the adapter and into the handle 150. Thus, the internal channel 120 extends from an interior region of the handle 150 to the pores 114, with the sole openings into the channel being at the pores 114 and interior of the handle 150.

The handle 150 comprises a cylindrical housing for placement of toothpaste and a spring-loaded mechanism connected to and able to move a plunger from a bottom or distal portion of the handle towards a top or proximal portion of the device. The plunger seals the proximal portion of the handle which houses toothpaste from the distal rest of the handle. As the plunger moves up with each successive dispensed dose, the region of the handle where toothpaste may reside decreases and the toothpaste is forced into the channel 120. The channel 120 provides fluid communication to the pores by way of the adapter 130 and stem 116.

Now describing the adapter 130 in more detail, the adapter is removable from the handle in such a manner that the interior portion of the hollow handle may be accessed. A distal region of the adapter 130 engages with the handle 150. In an embodiment of the invention, the adapter contains threads adapted for fixed attachment to threads on the handle. However, any reasonable method of rigid and removable connection known in the art may be used. A proximal region of the adapter engages with the stem 116. In an embodiment of the invention, engagement with the stem 116 is accomplished with the use of one or more bisecting flanges 136 extending inward from the exterior of the adapter 130 to rigidly hold in place the stem 116 of the toothbrush at one or more recesses (not depicted). The recesses are designed for engagement with the bisecting flanges 136.

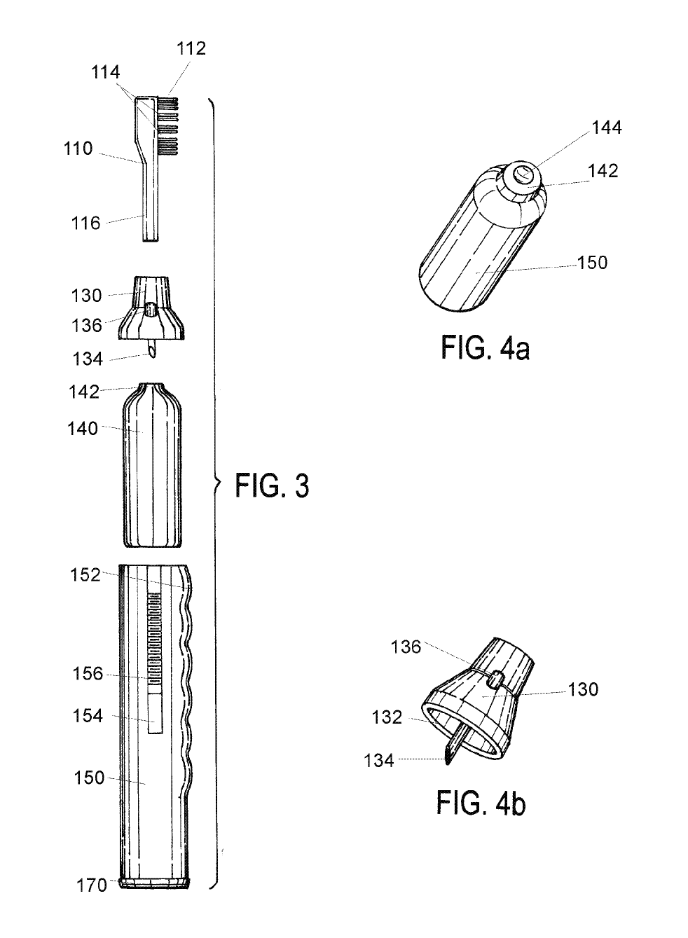

Referring again to FIG. 4b and additionally to FIG. 3, the adapter internal channel 120, in an assembled condition of the toothbrush and toothpaste holder of the invention, is in fluid communication with both the internal channel 120 of the head region 110 and the handle region 150. The internal channel 120 of the adapter 130 extends at least from the proximal to the distal ends of the adapter. In an embodiment of the invention, a stem 134 of the adapter allows the channel 120 to extend past the distal end of the adapter and into a central region of the handle 150. In an embodiment of the invention, the stem 134 is used to puncture a cartridge 140. The cartridge comprises toothpaste and is positioned within the hollow central region of the handle 150.

As best illustrated in FIG. 4a, a top perspective view of the cartridge with a puncture region 144 is shown. Further, FIG. 4b shows the stem of the adapter adapted for puncturing the puncture region 144 of the cartridge. The puncture region 144 is a relatively easy to tear region when direct force is applied with a sharp object. Materials such as plastics and rubbers, as described above and as are well known in the art, may be used for this purpose. The puncture stem 134 of the adapter 130 thus enters the cartridge so as to form fluid communication of toothpaste from the cartridge 140 into the channel 120. The puncturable area 144 is circumferentially surrounded by a rim 142 to protect the cartridge from ripping beyond the puncture zone and aid in providing sealed communication between the interior of a cartridge 140 and the channel 120. In an embodiment of the invention, such cartridges are optional, as toothpaste can be placed directly into the hollow handle 150. In another embodiment of the invention, the device is designed for use with a cartridge 140.

While the cartridge comprises toothpaste, in an embodiment of the invention, specifically formulated toothpaste for purposes of proper fluidity through the channel 120 may be used. This may be desired for medical reasons, so as to provide a precise amount of a drug or chemical in the toothpaste. For example, a precise amount of fluoride may be provided and delivered in each dose of toothpaste. This precise amount can be pre-calibrated. Whereas in conventional methods of using toothpaste and the prior art combination toothbrushes and toothpaste dispensers, the volume of medicine and other chemicals and compounds entering the mouth of a user could not be controlled, in the present invention the dosage can be dispensed accurately. Thus, the mixture of toothpaste can be preformulated so that a precise and set amount of medicine enters the mouth of a user with each application.

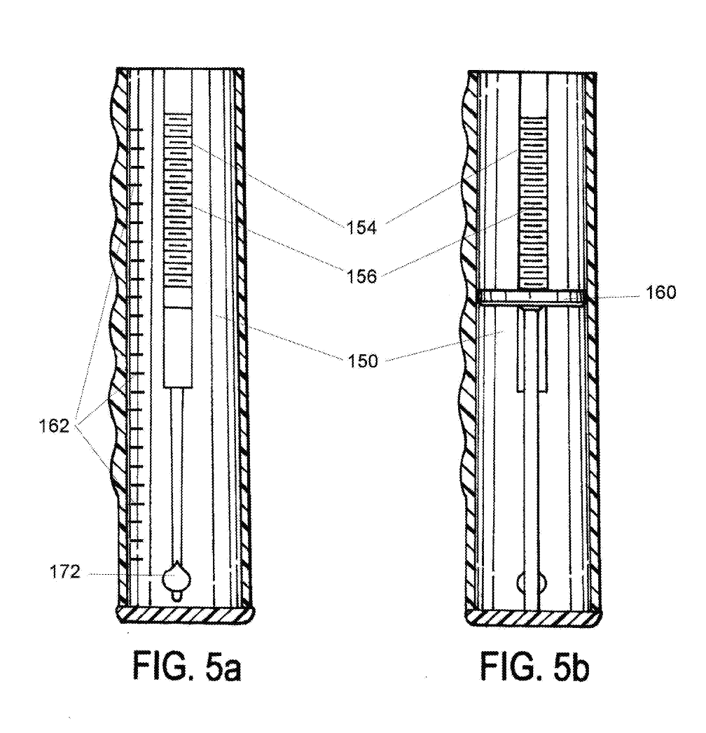

As best illustrated in FIGS. 5a and 5b, a caulkable plunger mechanism is provided for forcing dosed amounts of toothpaste from the cartridge 140 or interior portion of the handle 150 into the channel 120. In FIG. 5b, a plunger 160 coupled to a spring 164 (as shown in FIG. 2 and omitted for clarity in FIG. 5b) and caulking lever 166 is used to compress the toothpaste and force it into the channel 120. The caulking lever 166 is positioned such that it does not interfere with the user's grip of the handle. FIG. 5a shows an embodiment of the invention similar to that shown in FIG. 5b. FIG. 5b shows the handle 150 with notched recesses 162 provided in the cavity of the handle. A plunger 160 and spring 164 are not shown. These notches 162 are placed equidistant to one another or calibrated in such a manner that when the toothpaste is compressed, each movement of a plunger past a notch will result in a measured and substantially equal amount of toothpaste entering the channel 120. The notches may be somewhat flexible or bendable and inform the user through an audible sound and/or an increase in pressure on a button that a full dose has been dispensed. A typical calibration may, for example, be designed such that 10 ml of toothpaste enters the chamber at each “click” or movement from one notch to the next.

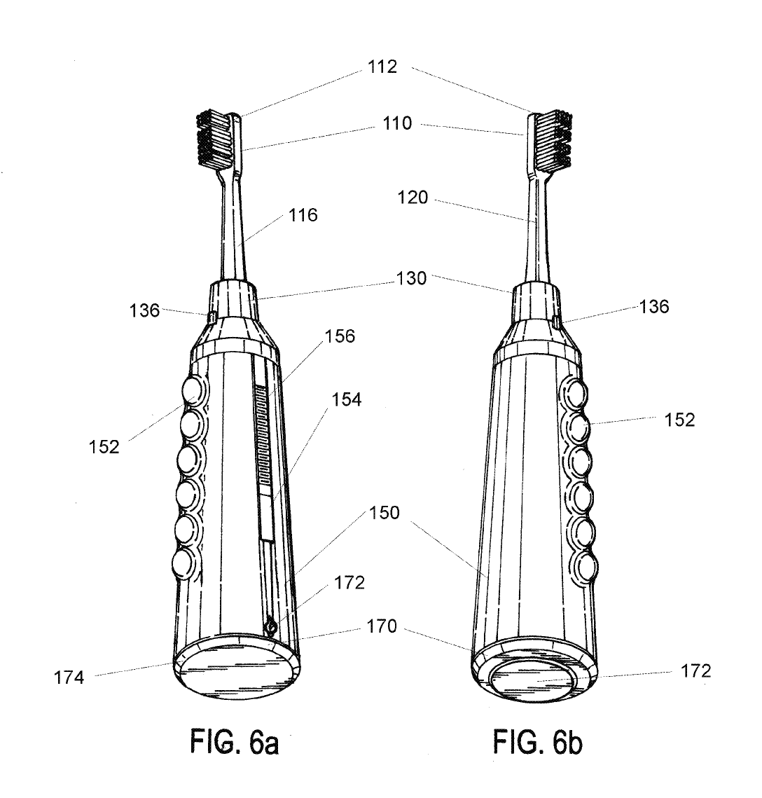

FIG. 6a shows a bottom perspective view of an embodiment of the invention, and FIG. 6b shows a bottom perspective view of another embodiment of the invention having a button positioned at the bottom end. The embodiment of FIG. 6b comprises a depressable button 172, whereas the embodiment of FIG. 6a includes a twistable button 174 to rotatably operate the piston mechanism. In the present embodiments, a lever or other positioning of the plunger, such as by manually compressing a spring-loaded plunger to fit a cartridge 140 or a desired volume of toothpaste into the handle 150, is used to position the plunger at a first position near the base of the device. Thus, in a starting position, a full cartridge 140 or full amount of toothpaste can be inserted into the handle 150. The adapter 130 is screwed or otherwise attached to the handle 150. Upon using the button 172 or 174, the plunger 160 moves from the first position near the base towards the head region 110 of the device. The device is configured so that the depressable button 172 or twistable button 174 moves a preset and known distance, causing a present and known amount of toothpaste to exit from the handle portion 150 and enter into the channel 120. It may be necessary to click or depress the button 172 or 174 more than one time during initial use, so that the channel 120 fills with toothpaste. Upon each successive press, a dose of toothpaste exits from the pores 114 and enters onto the bristles 112.

The caulking-piston mechanism of the invention is well known in the art, such as is described in U.S. Pat. No. 4,356,938 to Kayser, which is hereby incorporated by reference. It should be understood by one having ordinary skill in the art that any similar caulking mechanism, spring-loaded piston, or method of pushing toothpaste into the channel 120 may be employed and is within the scope and spirit of the invention.

It is desirable to have the toothbrush “click” to indicate to the user that a dose of toothpaste has been dispensed. This may be accomplished in numerous ways. In one embodiment of the invention, as illustrated in FIG. 5a, interior notches 162 are provided on the inner surface of the hollow handle 150. The notches allow the plunger to move in fixed increments through the handle 150 and provide a predetermined amount of toothpaste. In one embodiment, the notches are spaced apart at equidistant intervals, so that upon each use of a button 172 or 174, the cartridge 140 or toothpaste within the cavity of handle region 150 exits from the handle region and enters into the channel 120 in equal volumes per click. This volume may be pre-calibrated for accuracy.

Still further, as best illustrated in FIGS. 6a and 6b, embodiments of the invention comprise a gripping region 152 spaced apart from the buttons and levers of the invention. The gripping region 152 allows a user to hold and use the device in a comfortable manner without interfering with the mechanics of the device.

Still further, embodiments of the invention comprise a viewing window 154, allowing a user to view a plunger 160, toothpaste, or the internal portion of the handle 150. In embodiments of the invention, the viewing window 154 comprises gradations 156, which may be calibrated to provide a precise number of doses available based on the position of the plunger within the handle 150. When used in conjunction with an embodiment of the invention having notches 162, calibration is accomplished by positioning each gradation 156 at substantially the same position of each notch 162 in such a manner that the end of the plunger is positioned adjacent to a notch and corresponding gradation after each complete twist or pressing of a button 172 or 174.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and, accordingly, all suitable modifications and equivalents may be resorted to, falling within the scope of the invention.

I claim:

1. A combination toothbrush and toothpaste dispenser with calibrated and dosed dispensing comprising:
a proximal head formed integrally with a distal stem, said head further comprising a proximal bristled-region, said bristled-region further comprising perpendicularly extending bristles, a channel extending through said stem and head and opening into said bristled-region at one or more pores in said head, said channel further opening at a distal end of said stem;
a cylindrical housing, said cylindrical housing comprising a toothpaste-containing cavity therein, a proximal region of said toothpaste-containing cavity being connectable with said distal region of said stem and in fluid communication with said channel of said stem; and
a spring-loaded internal plunger disposed at a distal end of said toothpaste-containing cavity and providing a seal between said toothpaste containing cavity and a plunger cavity, said spring-loaded internal plunger being coupled to a spring-loaded button;
wherein upon each use of said button, said plunger extends a fixed distance into said toothpaste-containing cavity and a dosed volume of toothpaste exits from said cylindrical housing.

2. The combination toothbrush and toothpaste dispenser of claim 1, further comprising a toothpaste cartridge adapted for placement within said cavity, said toothpaste cartridge comprising toothpaste.

3. The combination toothbrush and toothpaste dispenser of claim 2, wherein said distal region of said stem further comprises a protruding distal end, said protruding distal end interfacing with said cartridge.

4. The combination toothbrush and toothpaste dispenser of claim 3, wherein said interfacing with said cartridge is by puncturing said cartridge with said protruding distal end of said stem.

5. The combination toothbrush and toothpaste dispenser of claim 1, wherein said use of said button comprises depression of said button.

6. The combination toothbrush and toothpaste dispenser of claim 1, wherein said use of said button comprises twisting said button.

7. The combination toothbrush and toothpaste dispenser of claim 1, wherein upon said plunger extending said fixed distance, a clicking noise is produced.

8. The combination toothbrush and toothpaste dispenser of claim 1, wherein said toothpaste-containing cavity comprises a plurality of calibrated notches.

9. The combination toothbrush and toothpaste dispenser of claim 8, wherein upon each use of said button, said plunger moves past one or more notches of said plurality of notches.

10. The combination toothbrush and toothpaste dispenser of claim 1, wherein said head is replaceable.

11. A toothpaste dispensing system comprising:
a handle further comprising a plunger, said plunger attached to a base via a spring, said handle further comprising a toothpaste cavity extending from said plunger to an adapter;
said adapter is adapted for fixed engagement with said handle and further comprises a connecting region for fixed engagement with a stem of a toothbrush, and a channel extends through said adapter;
said stem of said toothbrush forms a unitary structure with a toothbrush head, said toothbrush head comprising at least one pore, and said stem further comprising an internal channel in fluid communication with said channel of said adapter such that a continuous channel extends at least from said toothpaste cavity, through said adapter, and through said stem, said channel opening into at least one said pore of said head;
wherein said plunger moves a fixed distance upon using a button and a pre-calibrated amount of toothpaste enters into said channel.

12. The combination toothbrush and toothpaste dispenser of claim 11, further comprising a toothpaste cartridge adapted for placement within said toothpaste cavity.

13. The combination toothbrush and toothpaste dispenser of claim 12, wherein said channel extends through said adapter and said channel interfaces with said cartridge.

14. The combination toothbrush and toothpaste dispenser of claim 13, wherein said interface with said cartridge is by puncturing.

15. The combination toothbrush and toothpaste dispenser of claim 11, wherein said base comprises said button.

16. The combination toothbrush and toothpaste dispenser of claim 11, wherein upon engagement of said caulking lever, pressure is increased on said plunger.

17. The combination toothbrush and toothpaste dispenser of claim 11, wherein said button is selected from the group consisting of levers, depressable buttons, and twistable buttons.

18. The combination toothbrush and toothpaste dispenser of claim 11, wherein said toothpaste-containing cavity comprises positioned notches.

19. The combination toothbrush and toothpaste dispenser of claim 18, wherein upon each use of said button, said plunger moves past a said notch.

20. The combination toothbrush and toothpaste dispenser of claim 18, wherein said position of said notches is calibrated.
